(19) United States
(12) Patent Application Publication
(10) Pub. No.: US 2010/0115245 A1
(43) Pub. Date: May 6, 2010

(54) DETECTING AND RECOVERING FROM TIMING VIOLATIONS OF A PROCESSOR

(76) Inventor: Atsuya Okazaki, Yamato-shi (JP)

Correspondence Address: Dillon & Yudell LLP, 8911 N. Capital of Texas Hwy, Suite 2110, Austin, TX, 78759, US

(21) Appl. No.: 12/261,856

(22) Filed: Oct. 30, 2008

(51) Int. Cl. G06F 9/44

(52) U.S. Cl. 712/221

(57) ABSTRACT

A system for detecting and correcting invalid calculation results due to a timing violation. A processor compares results of an instruction simultaneously executed by a first arithmetic pipeline and a second arithmetic pipeline of the processor. In the second arithmetic pipeline, the critical stage of the first arithmetic pipeline is divided to multiple stages. A first result calculated by the first arithmetic pipeline is speculatively executed within the processor. The second arithmetic pipeline calculates a second result. The processor compares the second result to the first result. When the results are identical, the first result is assigned as the final result with a complete status. When the results do not match, the processor replaces the first result with the second result. The processor may then cancel the speculatively executed instruction and issue the second result as a final result. The processor may then restart subsequent instructions using the second result.

### BACKGROUND OF THE INVENTION

1. Technical Field

The present invention relates in general to processors. Still more particularly, the present invention relates to detecting and recovering from timing violations of a processor by implementing a second arithmetic pipeline.

2. Description of the Related Art

As miniaturization of semiconductor technology progresses, variability issues in production such as variations of dopant in a gate and line edge roughness (LER) becomes substantially more serious. To cope with these variability issues, countermeasures in semiconductor manufacturing process have been implemented. However, countermeasures at a circuit level and system architecture level are also needed.

### SUMMARY OF THE INVENTION

Disclosed is a system for detecting and correcting invalid calculation results due to a timing violation. A processor compares results of an instruction simultaneously executed by a first arithmetic pipeline and a second arithmetic pipeline of the processor. In the second arithmetic pipeline, the critical stage of the first arithmetic pipeline is divided to multiple stages. A first result calculated by the first arithmetic pipeline is speculatively executed within the processor. The second arithmetic pipeline calculates a second result of the instruction. The processor compares the second result to the first result. When the second result is identical to the first result, the first result is assigned as the final result with a complete status to the processor. When the results do not match, the processor replaces the first result with the second result. The processor may then cancel the speculatively executed instruction and issue the second result as a final result. The processor may then restart subsequent instructions using the second result.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, will best be understood by reference to the following detailed descriptions of an illustrative embodiment when read in conjunction with the accompanying drawings, wherein:

FIG. 1 is a block diagram of a computer in which the present invention may be implemented; and

FIG. 2. is a block diagram of an exemplary system for detecting and correcting invalid calculation results due to a timing violation.

FIG. 3. is a block diagram of an exemplary system for detecting and correcting invalid calculation results due to a timing violation.

FIG. 4. is a high-level logical flowchart of an exemplary method for detecting and correcting invalid calculation results due to a timing violation.

### DETAILED DESCRIPTION OF THE PREFERRED EMBODIMENT

The illustrative embodiments provide a system for detecting and correcting invalid calculation results due to a timing violation, in accordance with one embodiment of the invention.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that term is utilized.

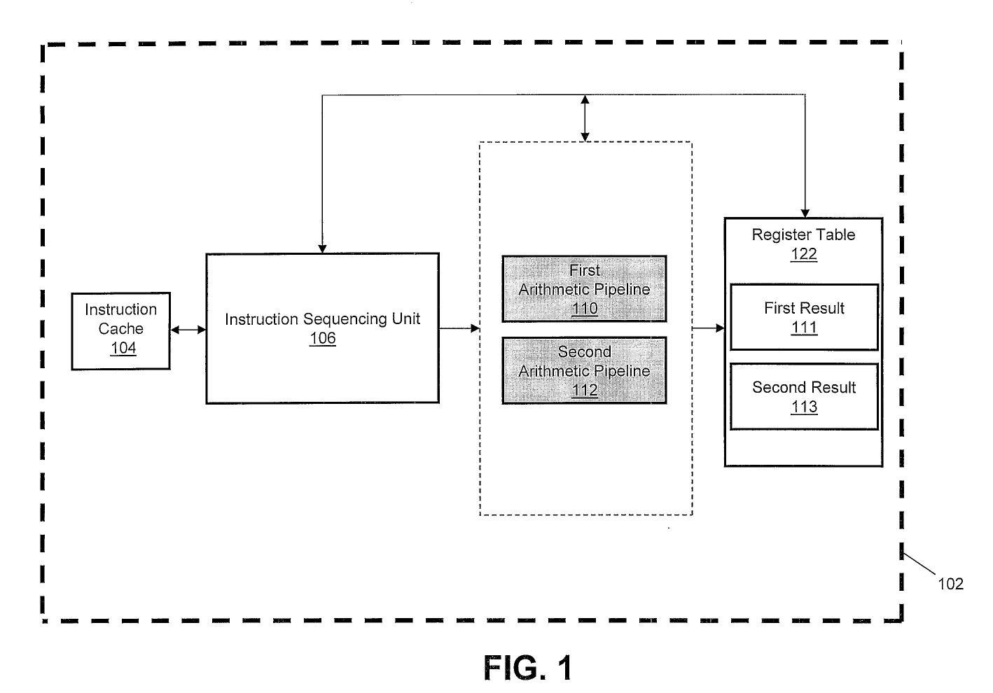

With reference now to FIG. 1, there is depicted a block diagram of a processor 102 in which the present invention may be implemented. Processor 102 includes instruction cache 104, instruction sequencing unit 106, first arithmetic pipeline 110, and second arithmetic pipeline 112. Processor 102 also includes a register table 122 that contains a first result 111 and a second result 113 of calculations performed by pipelines of processor 102.

Instruction sequencing unit 106 may fetch and order instructions for execution of to first arithmetic pipeline 110, and second arithmetic pipeline 112, and one or more execution units (not pictured) for executing instructions. Instruction sequencing unit 106 simultaneously transmits an instruction to first arithmetic pipeline 110, and second arithmetic pipeline 112. The first arithmetic pipeline110 has a fixed number of stages, n, to calculate a first result 112 of an instruction. The second arithmetic pipeline 112 inherently has an identified critical path stage. The second arithmetic pipeline 112 inherently has divided the critical path stage of the first arithmetic pipeline into two or more stages. As a result, second arithmetic pipeline 112 comprises one or more additional stages, n+1, to calculate a first result 112. Upon the first arithmetic pipeline 110, and second arithmetic pipeline 112 calculating a first result 111 and a second result 113, respectively, the results are stored in register table 122. Processor 102 is able to compare the first result 111 and second result 113 to determine when a timing violation has occurred.

The hardware elements depicted in processor 102 are not intended to be exhaustive, but rather are representative to highlight essential components required by and/or utilized to implement the present invention. For instance, processor 102 may also include other components such as a memory pipe, branch pipe unit, floating pipe unit, and fixed pipe unit.

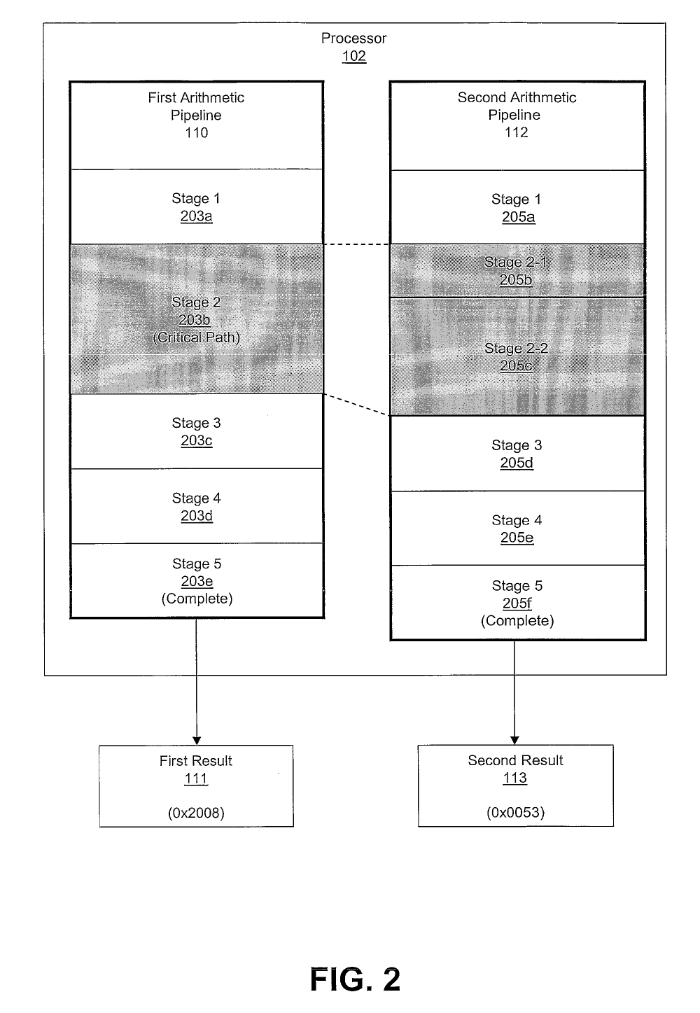

With reference now to FIG. 2, there is illustrated an exemplary system for detecting and correcting invalid calculation results due to a timing violation, in accordance with one embodiment of the invention. The illustrative embodiment is described from the perspective of the processor 102 autonomously comparing a first result 111 of a first arithmetic pipeline 110 with a second result 113 of a second arithmetic pipeline 112 to determine when a timing violation has occurred, and correct invalid calculation results due to a timing violation.

Processor 102 receives an instruction to be executed by both a first arithmetic pipeline 202 and a second arithmetic pipeline 204. First arithmetic pipeline 110 comprises one or more stages 203a-n, where n is an integer greater than one, to calculate a first result 111 of the instruction. In the second arithmetic pipeline, the critical stage of the first arithmetic pipeline is divided to multiple stages. As a result the second arithmetic pipeline 112 comprises n+x stages 203a-n, where x is an integer greater than one, to calculate a second result 111 of the instruction. By design, the increased number of stages 203a-n of the second arithmetic pipeline 204 causes the second arithmetic pipeline 110 to determine a second result 113 after the first arithmetic pipeline 110 has calculated a first result 111. However, because the critical path stage has been subdivided into two or more stages 205a-n in the second arithmetic pipeline 112, the results may be less susceptible to variation. First result 111 and second result 113 may be stored in a result table (e.g., result table 122, FIG. 1) of processor 102.

Processor 102 simultaneously executes an instruction within the first arithmetic pipeline 110 and the second arithmetic pipeline 112. The first arithmetic pipeline 110 comprises fewer stages 203a-n. Upon the first arithmetic pipeline 110 generating the first result 111 of the instruction, processor 102 speculatively executes the subsequent instruction using the first result 111. Upon the second arithmetic pipeline 112 determining a second result 113 of the selected calculation, processor 102 compares first result 111 with second result 113. When first result 111 and second result 113 are different, processor 102cancels any speculatively executing subsequent instructions, and replaces first result 111 with second result 113. Processor 102 may then assign a complete status to the second result 113, and restart the subsequent instruction using second result 113 as the final result. When first result 111 and second result 113 are identical, processor 102 assigns the first result 111 as the final result and changes the status of the instruction to complete.

For exemplary purposes, an instruction executed of first arithmetic pipeline 110 contains five stages 203a-e. The same instruction is executed with the second arithmetic pipeline 112. Second arithmetic pipeline 112 comprises of seven stages 205a-f. For the second arithmetic pipeline 112, a critical path stage, stage 203b, is subdivided into multiple stages 205b-c to increase the likelihood of the second result 113 being correct. When first arithmetic pipeline 110 calculates the first result 111 to be 0x2008, processor 102 speculatively executes the subsequent instruction. Upon second arithmetic pipeline 112 calculating the second result 113 to be 0x0053, processor 102 compares both results. Processor 102 may then determine that the two results are different, and replaces first result 111, with second result 113 within the register table (e.g., register table 122, FIG. 1). Processor 102 may then cancel the speculatively-executed instruction and restart the subsequent instruction using second result 113 as the final result.

In an alternate embodiment, the second arithmetic pipeline 112 may only comprise of the subdivided stages 205a-n of the critical path stage. Processor 102 may then compare the results of only the critical operation stages of both pipelines, and not the entire result. Processor 102 may then substitute the result of the critical path stages 205b-c of the second arithmetic pipeline 112 for the result of the critical operation stage 203b of the first arithmetic pipeline 110 when the results do not coincide.

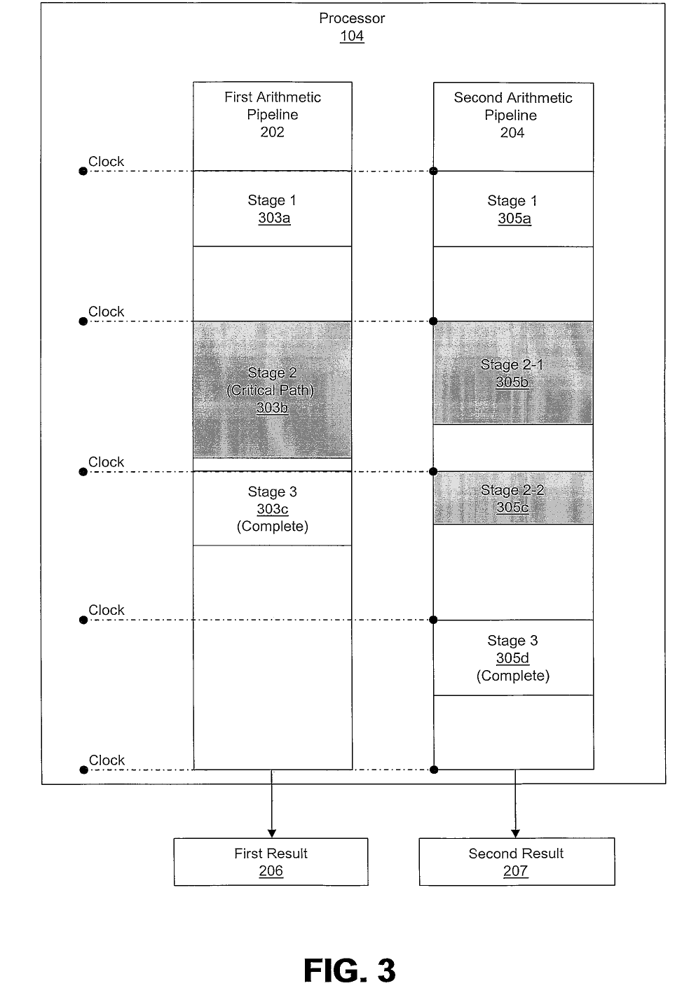

With reference now to FIG. 3, there is illustrated an exemplary system for detecting and correcting invalid calculation results due to a timing violation, in accordance with one embodiment of the invention. The illustrative embodiment demonstrates one embodiment of the invention in which each stage of an instruction executed of both pipelines occurs at the start of each clock cycle of a processor. In this implementation an additional clock count is added to the overall processing time needed for the second arithmetic pipeline 212 to arrive at a second result 213.

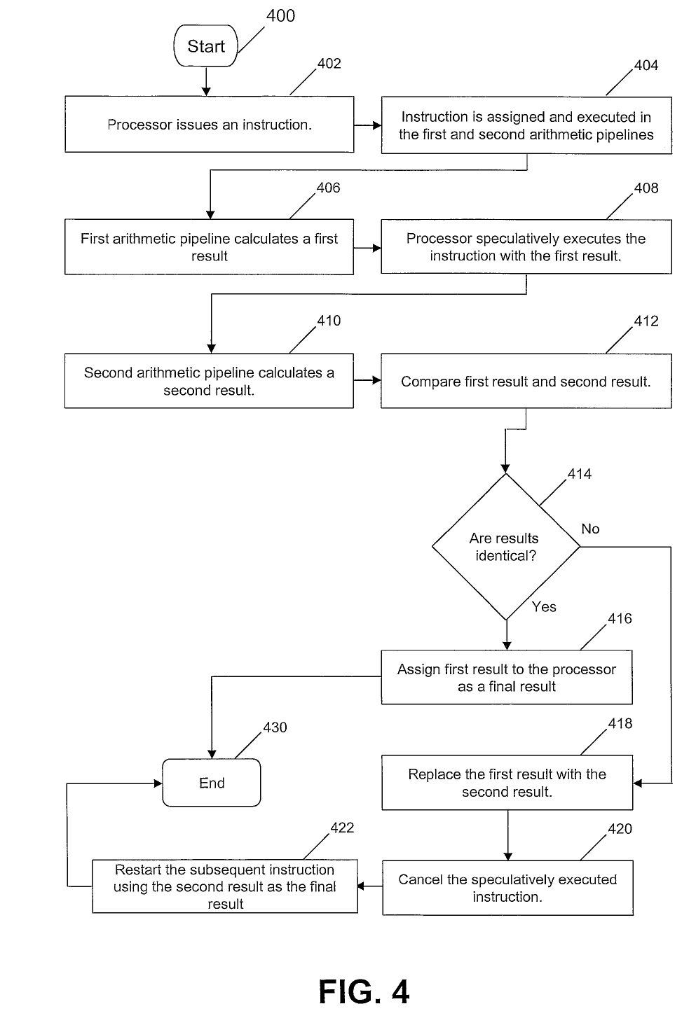

With reference now to FIG. 4, a high-level logical flowchart of an exemplary method for detecting and correcting invalid calculation results due to a timing violation. In the run time, after initiator block 400, the processor issues an instruction executed by the pipeline (block 402). The instruction is assigned and executed in both first arithmetic pipeline and second arithmetic pipeline (block 404). The first arithmetic pipeline calculates the first result (block 406). Then, the processor speculatively executes the subsequent instruction with the first result if the subsequent instruction requires the first result (block 408). The second arithmetic pipeline calculates a second result (block 410). Then, the processor compares the first result to the second result (block 412).

The processor may then compare the first result and the second result (block 414). When both results are identical, the processor assigns the first result to the processor as a final result and the status of the instruction is changed to complete (block 416), and the process ends at terminator block 430. When the first result and the second result do not coincide, the processor replaces the first result with the second result (block 418). The processor may then cancel the speculatively-executed subsequent instruction (block 420), and restart the subsequent instruction using the second result as a final result. (block 422). The process ends at terminator block 430.

In the flow charts above, one or more of the methods are embodied in microcode such that a series of steps are performed when the processor is executed on a computing device. In some implementations, certain steps of the methods are combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

Although aspects of the present invention have been described with respect to a computer processor, it should be understood that at least some aspects of the present invention may alternatively be implemented as a program product for use with a data storage system or computer system. Programs defining functions of the present invention can be delivered to a data storage system or computer system via a variety of signal-bearing media, which include, without limitation, non-writable storage media (e.g. CD-ROM), writable storage media (e.g. a floppy diskette, hard disk drive, read/write CD-ROM, optical media), and communication media, such as computer and telephone networks including Ethernet. It should be understood, therefore, that such signal-bearing media, when carrying or encoding computer readable instructions that direct method functions of the present invention, represent alternative embodiments of the present invention. Further, it is understood that the present invention may be implemented by a system having means in the form of hardware, software, or a combination of software and hardware as described herein or their equivalent.

Having thus described the invention of the present application in detail and by reference to illustrative embodiments thereof, it will be apparent that modifications and variations are possible without departing from the scope of the invention defined in the appended claims. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A processor comprising:
a first arithmetic pipeline;
a second arithmetic pipeline having a greater number of operation stages than the first arithmetic pipeline
processing logic for:
transmitting an instruction to both the first and second arithmetic pipelines;
in response to a first result of execution of the instruction by the first arithmetic pipeline, speculatively executing subsequent instructions of the processor using the first result;
in response to the first result of execution of the instruction by the first arithmetic pipeline and a second result of execution of the instruction of the second arithmetic pipeline being different:
replacing the first result with the second result,
canceling the speculatively executing subsequent instructions of the processor,
restarting the subsequent instructions using the second result as a final result; and
in response to the first result and the second result being identical, assigning the first result as a final result.
